(19) United States
(12) Patent Application Publication
(10) Pub. No.: US 2012/0078590 A1
(43) Pub. Date: Mar. 29, 2012

(54) METHOD AND SYSTEM FOR CREATING MODEL DATA

(75) Inventors: Chen Hao, Beijing (CN); Qi Cheng Li, Beijing (CN); Jian Wang, Beijing (CN); Yi Min Wang, Shanghai (CN); Shun Xiang Yang, Beijing (CN); Zi Yu Zhu, Beijing (CN)

(73) Assignee: International Business Machines Corporation, Armonk, NY (US)

(21) Appl. No.: 13/238,158

(22) Filed: Sep. 21, 2011

(30) Foreign Application Priority Data
Sep. 29, 2010 (CN) 201010506180.2

(51) Int. Cl. G06F 17/50

(52) U.S. Cl. 703/1

(57) ABSTRACT

The invention provides a method and system for creating model data. The method comprises: obtaining initial model data that is based on thickness model; adjusting thickness of the part of vertices of the initial model data in response to user inputting thickness values of part of vertices; adjusting position of the part of vertices of the initial model data in response to user inputting position values of part of vertices; and obtaining model data that is based on thickness model according to the initial model data and the adjusted part of vertices. By employing the method or system of the invention, it will facilitate user to edit model data and it will also save storage space.

### CROSS-REFERENCE TO RELATED APPLICATION

This application claims priority under 35 U.S.C. §119 from Chinese Patent Application No. 201010506180.2 filed Sep. 29, 2010, the entire contents of which are incorporated herein by reference.

### BACKGROUND OF THE INVENTION

1. Field of the Invention

The invention generally relates to field of information processing technology, and in particular, to a method and system for creating model data.

2. Description of Related Art

According to statistics, in applications for representing various shapes of object, the representation of “shell-like shapes” such as clothes, seashell, kneeling chair, vase, and 3D map is over 50%. Current methods for generating 3D model data include method based on conventional mesh model, continuous representation method based on parametric surface (such as Bezier surface, spline surface), subdivision surface, implicit function surface and so on, and method based on solid model. As for the representation method for the above “shell-like shapes”, such as the manner of using traditional triangular face, face with two layers (upper and lower) is required so as to represent the models that have thickness. Since there is no constraint between the two layers, shape manipulation is difficult. When one layer is manipulated, the other layer will not make corresponding change automatically. Thus, correct correspondence between these two layers must be recorded, and the two layers have to be modified respectively while shape of model needs to be modified. It is very inconvenient for an user, and on the other hand, it will occupy large amount of storage space. If solid model is adopted, it will bring significant computing complexity to modeling and visualizing procedure. Meanwhile, as for most applications, the representation of solid model contains a significant portion of redundant information (such as internal data of the model), which will bring heavy storage burden.

Thus, what is needed is a method and system for creating model data, which will facilitate user to create or store model data.

### SUMMARY OF THE INVENTION

An aspect of the invention provides a method for creating model data, including: obtaining initial model data that is based on thickness model; adjusting thickness of at least one vertex of the initial model data in response to an user inputting thickness values for the at least one of the vertex; adjusting position of at least one vertex in response to the user inputting position values for the at least one vertex; and obtaining model data that is based on thickness model according to the initial model data and at least one adjusted vertex.

Another aspect of the invention provides a system for creating model data, including: vertex thickness adjusting means for, adjusting thickness of at least one vertex of the initial model data in response to an user inputting thickness values for the at least one of the vertex; vertex position adjusting means for, adjusting position of at least one vertex in response to the user inputting position values for the at least one vertex; and model data generating means for obtaining model data that is based on thickness model according to the initial model data and at least one adjusted vertex.

Another aspect of the invention provides a thickness model including 3D space coordinates of vertices and thickness of vertices, where thickness direction of the vertices are specified in model data file that is based on thickness model.

Another aspect of the invention provides a computer readable article of manufacture tangibly embodying non-transitory computer readable instructions which, when executed, cause a computer to carry out the steps of a method for creating model data, including: obtaining initial model data that is based on thickness model; adjusting thickness of at least one vertex of the initial model data in response to an user inputting thickness values for the at least one of the vertex; adjusting position of at least one vertex in response to the user inputting position values for the at least one vertex; and obtaining model data that is based on thickness model according to the initial model data and at least one adjusted vertex.

The method or system of the invention for generating model data that is based on thickness model makes it very easy to maintain and modify model data that is based on thickness model, user can edit a model by simply adjusting position and thickness of vertex of model data without taking into account correspondence between two layers of surfaces. This greatly facilitates modeling procedure and improves efficiency of modeling. Also, Storage of such model data significantly saves storage space.

### BRIEF DESCRIPTION OF THE DRAWINGS

In order to describe features and benefits of the embodiment of the invention in detail, the following drawings will be referred to. Where possible, same or similar reference number will be used in drawings and description to denote same or similar part, in which:

FIG. 1 shows basic operation performed on model data that is based on thickness model.

FIG. 2 shows a first embodiment of the invention for creating model data.

FIG. 3 shows a second embodiment of the invention for creating model data.

FIG. 4 shows a first embodiment of the invention for obtaining initial model data that is based on thickness model.

FIG. 5 shows a second embodiment of the invention for obtaining initial model data that is based on thickness model.

FIG. 6 shows a third embodiment of the invention for obtaining initial model data that is based on thickness model.

FIGS. 7, 8 show an embodiment of the invention for converting model data that is based on thickness model to model data that is based on existing mesh model.

FIG. 9 shows a block diagram of a system of the invention for creating model data.

### DETAILED DESCRIPTION OF THE PREFERRED EMBODIMENTS

The detail description will be presented with reference to exemplary embodiments of the invention, examples of the embodiments are illustrated in the drawings, in which same reference number denote same element throughout the description. It should be appreciated that, the invention is not limited to the disclosed exemplary embodiments. It should also be appreciated that, not every feature of the method and device is necessary for implementing the invention claimed in any one of claims. Further, throughout the disclosure, when a process or method is shown or described, steps of the method can be performed in any order or simultaneously, unless it is obvious from context that one step depends on another step performed previously. Further, there can be significant time interval between steps.

There are many drawbacks in modeling method based on existing mesh model or modeling method based on solid model, and they can not satisfy the need of current or future application. The invention, however, finds a new way and provides a thickness model to overcome one or more drawbacks in the art. As shown in Table 1, a thickness model includes 3D space coordinates X, Y, Z of vertices of model data and thickness values T corresponding to the vertices. However, thickness direction can be arranged flexibly, for example, in model data file, it is uniformly prescribed that all thickness directions are along normal direction of vertex, or that thickness directions point to a same direction (such as a sphere with thickness, vertices thereon all point to centre of the sphere), a same axis (assume that the axis is represented as X=X₀, Y=Y₀, then thickness direction of any vertex ((Xᵢ, Yᵢ, Zᵢ) on thickness model is ((Xᵢ-X₀), (Yᵢ-Y₀), 0), where i is a natural number)) and so on. A vertex V of model data based on thickness model can be represented as Vᵢ(Xᵢ, Yᵢ, Zᵢ, Tᵢ). Those skilled in the art can appreciate that, thickness direction of each vertex of model data can also be defined separately, so that a vertex V of model data that is based on thickness model can be represented as Vᵢ(Xᵢ, Yᵢ Zᵢ Tᵢ Dᵢₓ, D_{iy}, D_{iz}). By connecting each adjacent vertex of model data that is based on thickness model with edges, face with thickness of model data that is based on thickness model can be formed, the detail of which is shown in Table 2. A model file contains vertex list (Table 1) and face list (Table 2). The following is a simple example of model data file that is based on thickness model:

total number of vertices;

total number of faces; thickness direction (such as normal direction, point to fixed point, or point to fixed axis);

vertex list (such as table 1);

face list (such as table 2).

TABLE 1

| Vertex | X | Y | Z | Thickness |
|---|---|---|---|---|
| V1 | X1 | Y1 | Z1 | T1 |
| V2 | X2 | Y2 | Z2 | T2 |
| . . . | . . . | . . . | . . . | . . . |

TABLE 2

| Face | Vertex |
|---|---|
| F1 | V1, V2, V3 |
| F2 | V2, V4, V5 |
| . . . | . . . |

FIG. 1 shows basic operation performed on model data that is based on thickness model. The basic operations performed on model data include for example adding new vertex (subdividing current face), changing position of vertex, and changing thicknesses of vertex. For example, a new vertex can be added at centre of certain current face, and thickness of the new vertex can be constructed by interpolating thickness of each original vertex in the face. Then, position and thickness of the new vertex can be further adjusted to achieve the purpose of editing and creating model data.

Thickness model is a new way for representing basic model; it is especially suitable to represent object with thickness, and in fact, such object is ubiquitous. The function of thickness model is powerful in that it can flexibly represent model with different thickness at each part by merely maintaining a single-layer structure. It is very easy to maintain and modify model data of a thickness model, a user can edit the model by simply adjusting position of vertex of model data and its accompanying thickness without taking into account correspondence between two layers of surfaces (the two layers can automatically maintain correct correspondence). This significantly facilitates modeling procedure. Based on representation of thickness model, its feature can be further utilized so as to design a series of novel model creating and editing tools, which will greatly facilitate existing operations and provide stronger functions.

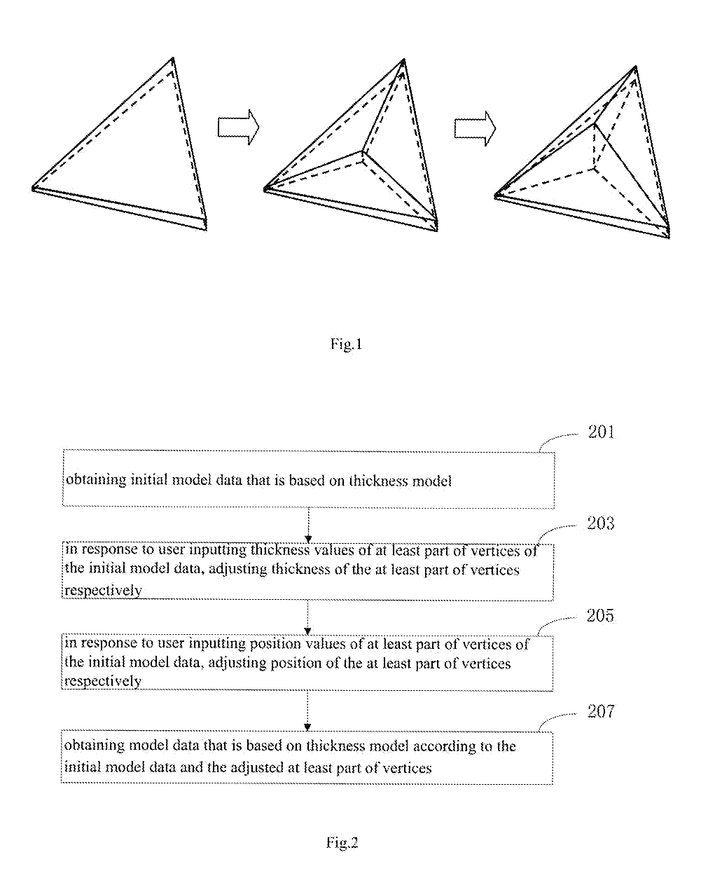

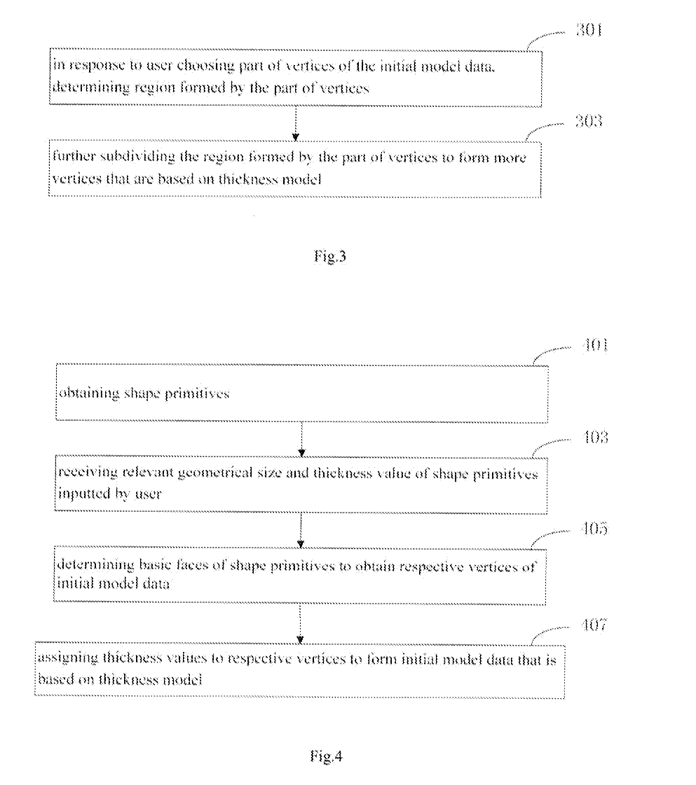

FIG. 2 shows a first embodiment of the invention for creating model data. In step 201, initial model data that is based on thickness model is obtained. The initial model data that is based on the above thickness model can be obtained in various manners. For example, it can be formed by user choosing shape primitives close to an object to be constructed, and can also be obtained by converting present model data that is based on existing mesh model. The above two illustrated manners for obtaining initial model will be described in detail below. There can also be other manner such as using existing model data that is based on thickness model as initial model data.

In step 203, in response to user inputting thickness values of at least part of vertices of the initial model data, thickness of the at least part of vertices are adjusted respectively. An user can use various input manners, for example, external input devices such as mouse or keyboard; an user can adjust the thickness of part of vertices of the initial model data by choosing part of vertices of the initial model data, stretching or dragging one or more vertices therein, and can also adjust the thickness of part of vertices of the initial model data by the user inputting height value of each vertex respectively. Thickness direction of vertices of initial model data can be directly defined by model data file. An user can also input thickness direction of part of vertices to achieve the required special shape. By adjusting thickness of part of vertices of the initial model data respectively, an user can relatively freely modify and edit model data and does not need to take much consideration in specific position of vertices in thickness direction; moreover, various free choices in thickness direction enhance shaping function. Unlike the present embodiment, existing shaping method can not perform shaping and modeling with respect to free-form surface as needed.

In step 205, in response to an user inputting position values of at least part of vertices of the initial model data, positions of the at least part of vertices are adjusted respectively. An user can also use various input manners, for example, external input devices such as a mouse or keyboard; an user can adjust positions of part of vertices of the initial model data by choosing part of vertices of the initial model data and dragging one or more vertices therein, and can also adjust positions of part of vertices of the initial model data by user inputting 3D coordinate value of each vertex respectively. It is worth noting that, there is no time sequential relationship between the above step 203 and step 205, that is, an user can first adjust positions of part of vertices as needed and then adjust thickness of part of vertices. An user can also only adjust positions of part of vertices, or adjust thickness of part of vertices.

In step 207, model data that is based on thickness model is obtained according to the initial model data and the adjusted at least part of vertices. Position and thickness data of the adjusted part of vertices is recorded; and in conjunction with position, thickness data of unadjusted vertices in initial model data form model data that is based on thickness model. The obtained model data that is based on thickness model saves much more storage space than existing model data that is based on other model and provides operational inconvenience for further modification by subsequent users.

Preferably, after thickness or positions of part of vertices are adjusted, part of vertices of the initial model data can at least be smoothed to obtain model data that is based on thickness model. In virtual world, some model needs rough surface (such as concavo-convex terrain), but some model needs smooth surface to obtain better visual effect. Technical details for smoothing a model can be found in Desbrun, M., Meyer, M., Schröder, P., and Barr, A. H. 1999, Implicit fairing of irregular meshes using diffusion and curvature flow, Proceedings of the 26th Annual Conference on Computer Graphics and interactive Techniques ACM Press/Addison-Wesley Publishing Co., New York, N.Y., 317-324, or Jones, T. R., Durand, F., and Desbrun, M. 2003, Non-iterative, feature-preserving mesh smoothing, ACM Trans. Graph. 22, 3 (July 2003), 943-949. Based on thickness model, various smoothing algorithms can be developed. The following is an exemplary smoothing process embodiment of the invention:

(1) computing adjacent vertex list of each vertex;

(2) updating position and thickness value of each vertex to weighted average of its adjacent vertices;

(3) if the user is satisfied with smooth degree of current model, the process ends; otherwise, computing in step (2) is executed again.

Sometimes, an user is not satisfied with local region of initial model data that is based on thickness model, and desires to further subdivide and modify the region so as to generate a more real shape. FIG. 3 shows a second embodiment of the invention.

In step 301, in response to the user choosing part of vertices of the initial model data, region formed by the part of vertices is determined. Similarly, the user can use various external input devices to choose part of vertices of the initial model data, for example, inputting region box through keyboard, or choosing a region by using mouse. Region of faces surrounded by edges connecting peripheral vertices in the part of vertices is used as the region formed by the part of vertices.

In step 303, the region formed by the part of vertices is further subdivided to form more vertices that are based on thickness model. If a region of model data that is based on thickness model is to be subdivided, a point can be automatically added at centre of each face of the region and a point is also added at centre of each edge. Then, a face is subdivided into a plurality of faces by connecting centre point in face to centre point in edge correspondingly. Initial position and thickness value of the newly added center vertex can be computed by interpolating surrounding vertices. The above subdividing action can be repeated until a user considers that number of local vertices of model is enough to describe shape of that local region. Also, there are various methods for subdividing a thickness model, such as, Loop subdivision method, the detail of which can be found in Charles Loop: Smooth Subdivision Surfaces Based on Triangles, M.S. Mathematics thesis, University of Utah, 1987, butterfly subdivision method, the detail of which can be found in Dyn, N., Levine, D., and Gregory, J. A. 1990. A butterfly subdivision scheme for surface interpolation with tension control. ACM Trans. Graph. 9, 2 (April 1990), 160-169. All these subdivision methods for triangular face can be extended to thickness model. All vertices can be further adjusted subsequently. When there are more vertices at local region which can be manipulated, more fine shape edit can be performed on the model. An user can also add vertices in corresponding region through, for example, a mouse, and compute thickness of the user added vertices by interpolating thickness of surrounding vertices. With the method for subdividing local region, the present embodiment provides an user with more flexibility in shaping.

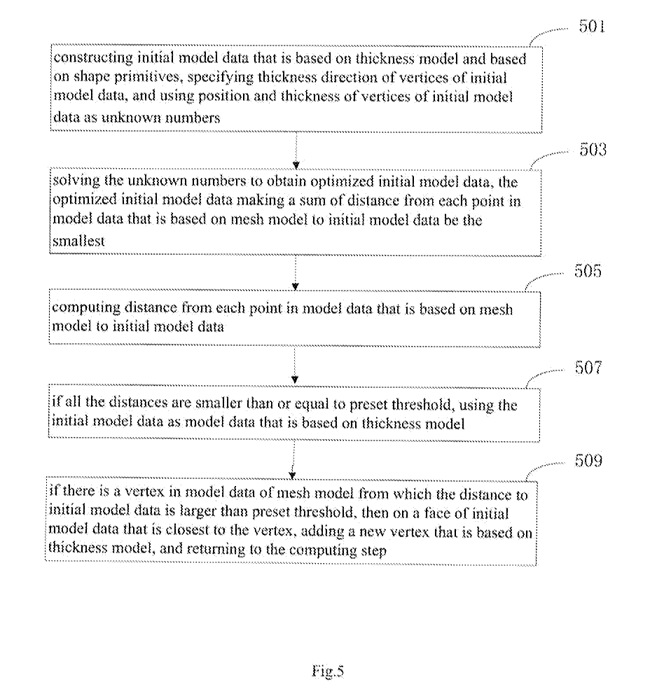

An user can utilize modeling tool that is based on thickness model to construct model data that is based on thickness model from the very beginning. FIG. 4 shows a first embodiment of the invention for obtaining initial model data that is based on thickness model. In step 401, shape primitives are obtained. Certain shape primitives close to common shape primitives (such as, plane, sphere, cylinder, cone) can be provided in advance, which can be defined by known analytical manner. The generation of respective subsequent vertices can be obtained by sampling on analytical model of shape primitives. The user can select shape primitives close to model data to be constructed from templates of editing tool that is based on thickness model.

In step 403, relevant geometrical size and thickness value of shape primitives inputted by user are received. First, the user determines relevant geometrical size and thickness value of shape primitives, for example, as for plane, user inputs its length size, width size, and inputs its thickness size at the same time; as for sphere, user inputs, for example, its radius size and thickness value of sphere. Then, according to different accuracy requirement, shaping tool can evenly sample on the plane and connect the sampled points into triangles with thickness one after another.

In step 405, basic faces of shape primitives are determined to obtain respective vertices of initial model data. Since shape is based on one shape primitive, all these shape primitives are single-layer structure with thickness, such as a plane with thickness. These faces with thickness can be regarded as basic face of model, and respective vertices obtained by sampling on basic face are used as respective vertices of initial model data. Preferably, by using the method for subdividing face as described above, more vertices of initial model data can be obtained.

In step 407, thickness values are assigned to respective vertices to form initial model data that is based on thickness model. Thickness values inputted by user are directly assigned to respective vertices of initial model data. As a result, respective vertices have thickness values. The thickness values can be identical, or be different depending on regions, or even all the thickness values of respective vertices are different. After respective vertices and corresponding thickness values and thickness directions are obtained, initial model data that is based on thickness model is obtained. The user can make further edition on the shape according to that initial model data.

Another application scenario is that an user already has model data that is based on existing mesh model (such as triangular mesh model). Due to limitation in editing tool that is based on existing model, the user can not obtain satisfying model data. It can be considered to convert model data that is based on existing model to initial model data that is based on thickness model. FIG. 5 shows a second embodiment of the invention for obtaining initial model data that is based on thickness model. In step 501, initial model data that is based on thickness model and based on shape primitives is constructed, thickness directions of vertices of initial model data are specified, and position and thickness of vertices of initial model data are used as unknown numbers. An user only needs to specify basic type of shape primitives, for example, whether it is a plane, a cylinder plane or a sphere plane. Number of vertices can be a relatively small number at beginning, such as 50 vertices. During subsequent optimizing procedure, new vertices can be added continually as needed. Thickness direction can be along normal direction of vertex. Position and direction of vertex are considered as unknown numbers.

In step 503, the unknown numbers are solved to obtain optimized initial model data, the optimized initial model data makes a sum of distance from each point in model data that is based on mesh model to initial model data be the smallest. Since positions and directions of vertices in thickness model are all unknown numbers, optimization object function needs to be established so as to solve the unknown numbers. Assume that original mesh model contains n vertices, n is a natural number, distance from each vertex P, to new thickness model is represented as function fᵢ, about vertex on thickness model, then the optimization object function is F=fᵢ+f₂+ . . . -fₙ, fᵢ is distance from each vertex Pᵢ to new thickness model S. Where, fᵢ=d(Pᵢ,S)=min_{Tj}ε_{S}) d(Pᵢ, Tⱼ), d(Pᵢ,S) represents distance from vertex Pᵢ to new thickness model S, Tⱼ is any triangular face with thickness in thickness model, d(Pᵢ, Tⱼ) represents distance from vertex Pᵢ to new triangular face with thickness Tⱼ, min( ) is a minimum value function, and d(Pᵢ, Tⱼ)=min(dⱼ₁, dⱼ₂), dⱼ₁, dⱼ₂ are distances from vertex Pᵢ to two (upper and lower) triangular faces of triangular face with thickness, where detailed method for obtaining two (upper and lower) faces of one triangular face with thickness can be found in FIG. 7 and relevant content in the description below. Further, detailed algorithm for computing distances dⱼ₁, dⱼ₂ from one point Pᵢ to one triangular face can be found in document “Distance Between Point and Triangle in 3D”, David Eberly, Geometric Tools, LLC (http://www.geometrictools.com/Documentation/DistancePoint3Triangle3.pdf). Then, position and thickness values of a set of vertices on thickness model are found to make value of F be the smallest, and since it belongs to common solving problem of optimal objective function in the art, it will not be described here for brevity.

In step 505, distances from each point in model data that is based on mesh model to initial model data are computed. Detailed algorithm for calculating distance from each point in model data that is based on mesh model to initial model data can be found in the above document.

In step 507, if all the distances are already smaller than or equal to preset threshold E (such as E is set as 0.5% of total model size), the initial model data is used as initial model data that is based on thickness model.

In step 509, if there is a vertex in model data of mesh model from which the distance to initial model data is larger than preset threshold, then the above subdivision method can be employed, that is, on a face of initial model data that is closest to the vertex, a new vertex that is based on thickness model is added, and the process returns to the above step 503 to perform further computation so as to finally obtain initial model data that is based on thickness model.

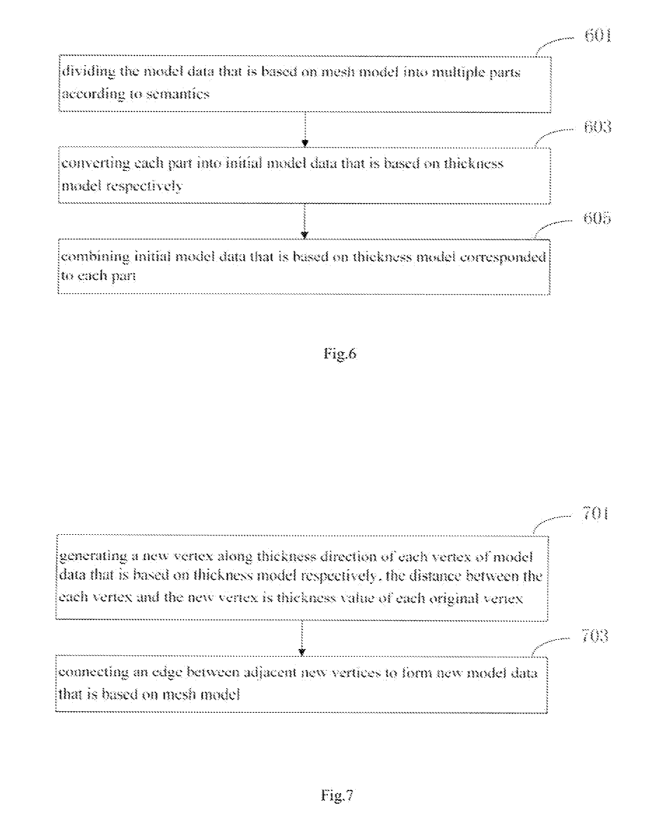

FIG. 6 shows a third embodiment of the invention for obtaining initial model data that is based on thickness model. Actually, model data that is based on existing mesh model is often formed by a plurality of components that are relatively independent. For example, a kneeling chair is often formed by relative independent parts such as chair's backboard, chair's base, armrest and chair's leg and so on. It is desirable for user to convert such complex model data that is based on existing mesh model to model data that is based on thickness model. In step 601, the model data that is based on mesh model is segmented into multiple parts according to semantics. There are various methods for segmentation of model data that is based on mesh model into multiple parts according to semantics, details thereof can be found in document: Youyi Zheng and Chiew-Lan Tai. Mesh Decomposition with Cross-Boundary Brushes. Computer Graphics Forum (Proceedings of Eurographics 2010).

In step 603, each part is converted into initial model data that is based on thickness model respectively. Converting each part into initial model data that is based on thickness model respectively can be performed according to the method shown in FIG. 5. In step 605, initial model data that is based on thickness model corresponded to each part is combined. Here, different parts can simply be placed in close adjacent to each other.

Based on the above-described method, an example of shaping kneeling chair by user will be exemplarily explained below. An user first chooses a plane with uniform thickness as shape primitive through an editing tool that is based on thickness model. The user sets size and thickness of the plane so as to construct a plane model, and adjusts angle of the entire plane and makes it slightly incline backwards. By changing positions of some vertices on the plane, shape of the plane is slightly bended, and then thicknesses of model vertices are adjusted so as to make gradual change in thicknesses from bottom to top. Now, details need to be added into the model: a local region into which details need to be added can be chose and is subdivided so that it will have more vertices. The user adjusts thickness of local vertices in this region to form a shape with protuberance in the centre, and the change in this part is reproduced to other parts of the model. The entire model is smoothed, such that modeling of chair's backboard is complete. Next, parts such as chair's plane, armrest, chair's leg can be modeled.

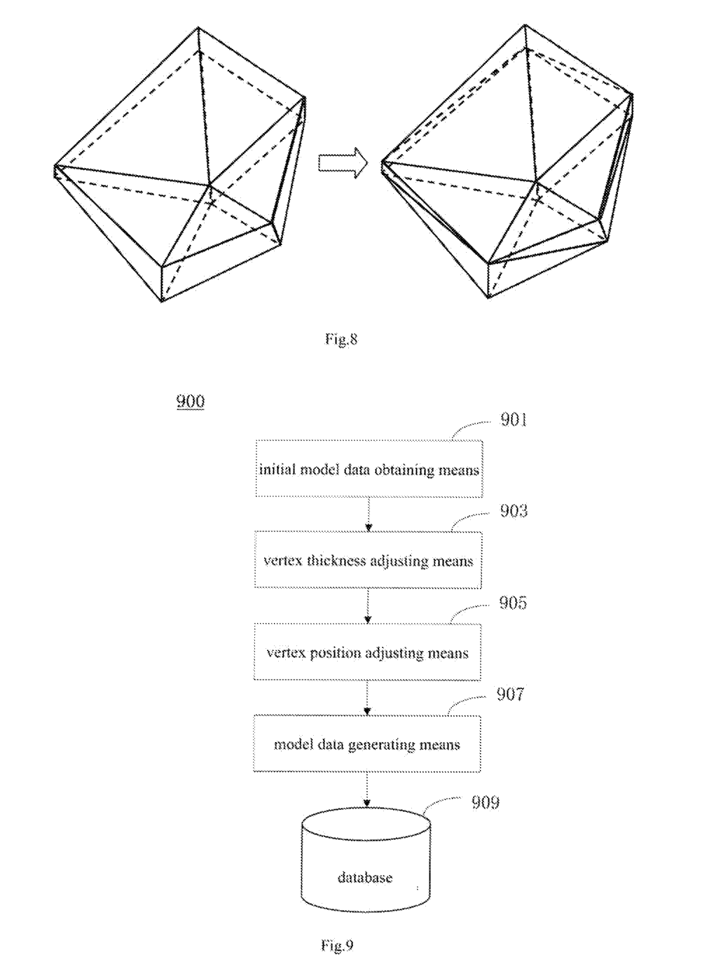

Since existing rendering technology and many shape editing tools mainly are based on existing mesh model, there is a need to convert model data that is based on thickness model to model data that is based on existing mesh model. FIG. 7 shows an embodiment of the invention for converting model data that is based on thickness model to model data that is based on existing mesh mode. In step 701, a new vertex is generated along thickness direction of each vertex of model data that is based on thickness model respectively, the distance between the each vertex and the new vertex is thickness value of each original vertex. Specifically, assume that one vertex of model data that is based on thickness model is Vₘ(Xₘ, Yₘ, Zₘ, Tₘ), m is a natural number, that is, 3D coordinates of that vertex is (Xₘ, Yₘ, Zₘ), thickness is Tₘ, then two new vertices Vₘ₁(Xₘ, Yₘ, Zₘ) and Vₘ₂=Vₘ₁+Tₘ×n can be obtained, n is the unit normal vector at Vₘ. For each vertex, vertices in its corresponding thickness direction are generated, such that two layers of vertices are obtained, one is original layer of vertices and the other is a newly generated layer of vertices. In step 703, an edge is connected between adjacent new vertices to form new model data that is based on mesh model. Each vertex of the newly generated layer of vertices and its originally corresponded vertex is connected to each other, and plus the respective vertices that are connected previously, model data that is based on conventional mesh model is thus obtained. Preferably, if a vertex is on boundary of the model data that is based on thickness model, then an edge is connected between two new vertices formed by dividing that vertex. In this manner, several quadrangular faces are in turn formed. If it is desirable to obtain model data that is based on triangular mesh, then an edge can be added to each quadrangular face so as to change it into two triangles. FIG. 8 illustratively shows the case of converting model data that is based on thickness model of the invention into model data that is based on mesh model.

The invention also provides a system 900 for creating model data, and FIG. 9 shows a diagram of its system architecture. The system 900 for creating model data comprises initial model data obtaining means 901, vertex thickness adjusting means 903, vertex position adjusting means 905, model data generating means 907. The initial model data obtaining means 901 is used to obtain initial model data that is based on thickness model; vertex thickness adjusting means 903 is used to, in response to user inputting thickness values of at least part of vertices of the initial model data, adjust thickness of the at least part of vertices respectively; vertex position adjusting means 905 is used to, in response to user inputting position values of at least part of vertices of the initial model data, adjust position of the at least part of vertices respectively; model data generating means 907 is used to obtain model data that is based on thickness model according to the initial model data and the adjusted at least part of vertices. Finally, the obtained model data that is based on thickness model is stored in database 909. Since specific methods related to the above means are already explained in detail above, they will be omitted for sake of brevity.

Preferably, system 900 further includes means for, in response to user choosing part of vertices of the initial model data, determining region formed by the part of vertices; and means for further subdividing the region formed by the part of vertices to form more vertices that are based on thickness model.

Preferably, the initial model data obtaining means 901 further includes: means for obtaining shape primitives; means for receiving relevant geometrical size and thickness value of shape primitives inputted by user; means for determining basic faces of shape primitives to obtain respective vertices of initial model data; means for assigning thickness values to respective vertices to form initial model data that is based on thickness model.

Preferably, the initial model data obtaining means 901 includes: means for converting model data that is based on mesh model to initial model data that is based on thickness model.

Preferably, the means for converting model data that is based on mesh model to initial model data that is based on thickness model includes: means for constructing initial model data that is based on thickness model and based on shape primitives, specifying thickness direction of vertices of initial model data, and using position and thickness of vertices of initial model data as unknown numbers; means for solving the unknown numbers to obtain optimized initial model data, the optimized initial model data making a sum of distance from each point in model data that is based on mesh model to initial model data be the smallest; means for computing distance from each point in model data that is based on mesh model to initial model data; means for, if all the distances are smaller than or equal to preset threshold, using the initial model data as model data that is based on thickness model; means for, if there is a vertex in model data of mesh model from which the distance to initial model data is larger than preset threshold, then on a face of initial model data that is closest to the vertex, adding a new vertex that is based on thickness model.

Preferably, the system 900 further includes: means for dividing the model data that is based on mesh model into multiple parts according to semantics; means for converting each part into initial model data that is based on thickness model respectively; and means for combining initial model data that is based on thickness model corresponded to each part.

Preferably, the system 900 further includes: means for generating a new vertex along thickness direction of each vertex of model data that is based on thickness model respectively, the distance between the each vertex and the new vertex is thickness value of each original vertex; and means for connecting an edge between adjacent new vertices to form new model data that is based on mesh model.

Preferably, the system 900 further includes: means for, if a vertex is originally on boundary of the model data that is based on thickness model, connecting an edge between that vertex and new vertex corresponded to that vertex.

Preferably, the thickness model comprises 3D space coordinates of vertex and thickness of vertex.

Preferably, thickness directions of the vertices are specified in model data file that is based on thickness model.

Further, the method for the invention for creating model data can also be implemented by computer program product, the computer program product includes software code portions for implementing the simulation method for the invention when the computer program product is running on the computer.

The invention can also be implemented by recording a computer program in computer readable record medium, the computer program includes software code portions for implementing the simulation method for the invention when the computer program is running on the computer. That is, the procedure of simulation method according to the invention can be distributed in form of instructions within computer readable medium and various other forms regardless of particular type of signal bearing medium for actually performing the distribution. Examples of computer readable medium include media such as EPROM, ROM, magnetic tape, paper, floppy disk, hard drive, RAM and CD-ROM and transmission media such as digital and analog transmission link.

Although the invention has been particularly shown and described with reference to preferred embodiments of the invention, those skilled in the art will appreciate that, various modifications in forms and details thereof can be made without departing from the scope and spirit of the invention defined by appended claims.

1. A method for creating model data, comprising:
obtaining initial model data that is based on thickness model;
adjusting thickness of at least one vertex of the initial model data in response to an user inputting thickness values for the at least one of the vertex;
adjusting position of at least one vertex in response to the user inputting position values for the at least one vertex; and
obtaining model data that is based on thickness model according to the initial model data and at least one adjusted vertex.

2. The method according to claim 1, further comprising:
determining a region formed by at least one vertex in response to the user choosing the at least one vertex of the initial model data; and
further subdividing the region formed by the at least one vertex to form more vertices that are based on thickness model.

3. The method according to claim 1, wherein obtaining initial model data that is based on thickness model comprises:
obtaining shape primitives;
receiving relevant geometrical size and thickness value of the shape primitives inputted by the user;
determining basic faces of the shape primitives to obtain respective vertices of the initial model data; and
assigning thickness values to the respective vertices to form the initial model data that is based on thickness model.

4. The method according to claim 1, wherein obtaining initial model data that is based on thickness model comprises:
converting model data that is based on mesh model to the initial model data that is based on thickness model.

5. The method according to claim 4, wherein converting the model data that is based on mesh model to the initial model data that is based on thickness model comprises:
constructing the initial model data that is based on thickness model and based on the shape primitives, specifying thickness direction of the vertices of the initial model data, and using the position and the thickness of the vertices of the initial model data as unknown numbers;
solving the unknown numbers to obtain optimized initial model data, the optimized initial model data making a sum of distance from each point in the model data that is based on mesh model to initial model data being the smallest;
computing distance from each point in the model data that is based on mesh model to the initial model data; using the initial model data as the model data that is based on thickness model if all the distances are smaller than or equal to preset threshold; and
adding, on a face of the initial model data that is closest to the vertex, a new vertex that is based on thickness model, and returning to the computing step, if there is a vertex in the model data of mesh model from which the distance to the initial model data is larger than the preset threshold.

6. The method according to claim 4, further comprising:
dividing the model data that is based on mesh model into multiple parts according to semantics;
converting each part into the initial model data that is based on thickness model respectively; and
combining the initial model data that is based on thickness model corresponded to each part.

7. The method according to claim 1, further comprising:
generating a new vertex along thickness direction of the vertex of the model data that is based on thickness model, wherein the distance between the vertex and the new vertex is thickness value of the vertex; and
connecting an edge between the adjacent new vertices to form the new model data that is based on mesh model.

8. The method according to claim 7, further comprising:
connecting the edge between the original vertex and the new vertex corresponded to the original vertex if the original vertex is on boundary of the model data that is based on thickness model.

9. The method according to claim 1, wherein the thickness model comprises 3D space coordinates of the vertex and thickness of the vertex.

10. The method according to claim 9, wherein the thickness directions of the vertices are specified in the model data file that is based on thickness model.

11. The method according to claim 1, wherein obtaining model data that is based on thickness model according to the initial model data and the adjusted at least part of vertices further comprises:
smoothing part of vertices of the initial model data.

12. A system for creating model data, comprising:
initial model data obtaining means for obtaining initial model data that is based on thickness model;
vertex thickness adjusting means for, adjusting thickness of at least one vertex of the initial model data in response to an user inputting thickness values for the at least one of the vertex;
vertex position adjusting means for, adjusting position of at least one vertex in response to the user inputting position values for the at least one vertex; and
model data generating means for obtaining model data that is based on thickness model according to the initial model data and at least one adjusted vertex.

13. The system according to claim 12, further comprising:
means for determining a region formed by at least one vertex in response to the user choosing the at least one vertex of the initial model data; and
means for further subdividing the region formed by the at least one vertex to form more vertices that are based on thickness model.

14. The system according to claim 12, wherein the initial model data obtaining means further comprises:
means for obtaining shape primitives;
means for receiving relevant geometrical size and thickness value of the shape primitives inputted by the user;
means for determining basic faces of the shape primitives to obtain respective vertices of the initial model data;
means for assigning thickness values to the respective vertices to form the initial model data that is based on thickness model.

15. The system according to claim 12, wherein the initial model data obtaining means comprises:
means for converting model data that is based on mesh model to the initial model data that is based on thickness model.

16. The system according to claim 15, wherein the means for converting the model data that is based on mesh model to the initial model data that is based on thickness model comprises:
means for constructing the initial model data that is based on thickness model and based on the shape primitives, specifying thickness direction of the vertices of the initial model data, and using the position and the thickness of the vertices of the initial model data as unknown numbers;
means for solving the unknown numbers to obtain optimized initial model data, the optimized initial model data making a sum of distance from each point in the model data that is based on mesh model to initial model data be the smallest; and
means for computing distance from each point in the model data that is based on mesh model to the initial model data;
means for using the initial model data as the model data that is based on thickness model if all the distances are smaller than or equal to preset threshold; and
means for adding, on a face of the initial model data that is closest to the vertex, a new vertex that is based on thickness model, and returning to the computing step, if there is a vertex in the model data of mesh model from which the distance to the initial model data is larger than the preset threshold.

17. The system according to claim 15, further comprising:
means for dividing the model data that is based on mesh model into multiple parts according to semantics;
means for converting each part into the initial model data that is based on thickness model respectively; and
means for combining the initial model data that is based on thickness model corresponded to each part.

18. The system according to claim 12, further comprising:
means for generating a new vertex along thickness direction of the vertex of the model data that is based on thickness model, wherein the distance between the vertex and the new vertex is thickness value of the vertex; and
means for connecting an edge between the adjacent new vertices to form the new model data that is based on mesh model.

19. The system according to claim 18, further comprising:
means for connecting the edge between the original vertex and the new vertex corresponded to the original vertex if the original vertex is on boundary of the model data that is based on thickness model.

20. The system according to claim 12, wherein the thickness model comprises 3D space coordinates of the vertex and thickness of the vertex.

21. The system according to claim 20, wherein the thickness directions of the vertices are specified in the model data file that is based on thickness model.

22. A thickness model comprising 3D space coordinates of vertices and thickness of vertices, wherein thickness direction of the vertices are specified in model data file that is based on thickness model.

23. A computer readable article of manufacture tangibly embodying non-transitory computer readable instructions which, when executed, cause a computer to carry out the steps of a method for creating model data, comprising:
obtaining initial model data that is based on thickness model;
adjusting thickness of at least one vertex of the initial model data in response to an user inputting thickness values for the at least one of the vertex;
adjusting position of at least one vertex in response to the user inputting position values for the at least one vertex; and
obtaining model data that is based on thickness model according to the initial model data and at least one adjusted vertex.
